(19) United States
(12) Patent Application Publication
(10) Pub. No.: US 2012/0181314 A1
(43) Pub. Date: Jul. 19, 2012

(54) Device and method for transporting elongate objects using a pick-up truck

(76) Inventor: Kevin Moore, Glendale, AZ (US)

(21) Appl. No.: 12/930,653

(22) Filed: Jan. 13, 2011

(51) Int. Cl. B60R 9/00

(52) U.S. Cl. 224/402

(57) ABSTRACT

A cab protection unit comprising a main frame pivotally attached to a load bearing frame; the main frame comprising a cross bar with to arms attached at each end of the cross bar; a yieldable structure attached to a bottom side of the main frame; and at least one support arm pivotally attached to at least one of the arms and configured to secure the load bearing frame into an open position; and the load bearing frame comprising a body having at least two load retention arms attached to one side of the body.

### FIELD OF THE INVENTION

The present invention relates generally to a device and method used in loading and transporting lengthy objects on a pick-up truck. More specifically, the present invention is a device and method for securing the lengthy objects to the pick-up truck such that they do not easily shift during transportation.

### BACKGROUND

Pick-up trucks are designed to safely transport objects of certain dimensions. However, when objects exceed these certain dimensions, they are more likely to shift in transport and even leave the vehicle. This usually occurs when the object is lengthy and has been propped against either the cab or the tailgate of the pickup truck. Examples are found in the transport of ladders, long boards, poles, and other lengthy objects.

Indeed, anyone who has traveled on the highways of an urban area has seen where improperly secured objects, such as ladders, boards and the like, have fallen out of a transporting vehicle and partially, or completely, obstruct the roadway. These are very dangerous situations.

The prior art shows numerous different attempts to address this and other needs. One commonly found solution is a rack that is mounted to the pick-up bed. The rack may or may not include a portion that overhangs the cab of the truck. While this aids in the transport of lengthy objects, it still relies upon the user to properly secure the objects to the rack. Also, for aesthetic and other reasons many vehicle owners will not mount a rack onto the bed of their truck. An example of this type of prior art device is fund in U.S. Pat. No. 5,067,644, issued to Coleman. This patent discloses a load carrying rack that is mounted onto a vehicle roof. The rack includes straps for securing the load to the rack device. Another example of this type of prior art device is illustrated in the drawings contained in U.S. Pat. No. 5,553,760 issued to Wright, et al. Yet another example is found in U.S. Pat. No. 3,884,404, issued to Frost.

Another prior art device is a multi-piece racking systems. An example of a multi-piece rack is found in U.S. Pat. No. 4,630,990, issued to Whiting. In this patent, there are two pieces to the racking system. A front piece that is mounted onto the cab of the truck, and a rear piece that is mounted onto the rear bumper of the truck. The large or long object to be transported is then placed upon the front and rear pieces. Straps are provided on each separate piece to secure the object being transported to the racking system. However, this entails the lengthy process of mounting and dismounting the separate pieces onto the truck. Further, it is a large bulky unit that is undoubtedly expensive and difficult to store. Yet another example is found in U.S. Pat. No. 3,884,404, issued to Frost.

Another type of solution has been to provide devices that are designed to protect specific portions of the truck exterior, such as the cab or the tailgate. An example of a cab protective device is found in U.S. Pat. No. 4,984,837, issued to Dise. This patent discloses a device that is mounted to a side portion of the cab, and extends over the top portion of the cab. Long objects are placed in the bed of the truck such that they extent over the cab and rest upon the device of the Dise patent. There are side arms that project upward to prevent the objects from sliding laterally off of the cab of the truck. Another example is found in U.S. Pat. No. 3,047,161, issued to Thacker. This device is a rack that mounts immediately behind the cab and projects up past the top of the cab. Long objects that extend past the cab are supported over the cab, thereby protecting the surface of the cab. Additionally, as in the Dise patent discussed above, there are portions of the rack that project up past the central portion to prevent unwanted lateral movement of the supported objects.

An example of a tailgate protecting device may be found in U.S. Pat. No. 4,389,067, issued to Rubio. This patent discloses a small rack that is mounted onto a top portion of the tailgate and that projects upward above the tailgate. Thus, objects that are placed in the bed of the truck and that extend past the tailgate rest upon the mounted rack and do not mar the surface of the tailgate. This device does not, however, address the problem of lateral movement of the supported object. Another example of a tailgate protection device may be found in US Design Patent No. DES. 387,722, issued to Fujinaka. This patent illustrates a device that appears to be mountable onto a top portion of the truck tailgate and that supports transported objects. As with the Fujinaka patent above, this device does not address the problem of lateral movement of the transported object.

Finally, U.S. Pat. No. 4,957,400, issued to Karp discloses a complex system of cab and tailgate protectors used in combination with a series of straps. A cab protector is mounted onto the cab, a tailgate protector is mounted onto the tailgate and the object is supported on the two protectors. Then a series of straps are attached to the truck at a variety of points, such as strap hooks and gutters commonly found on pick-up trucks. These straps securely hold the supported object to the protective devices.

However, there is still a clear and continuing need for devices and methods that aid in the transport of lengthy objects on a pick-up truck.

### SUMMARY OF THE INVENTION

It is an object of the present invention to provide a device and method for the transport of lengthy objects on a pick-up truck.

It is another object of the present invention to provide a device and method for the transport of lengthy objects on a pick-up truck that securely holds the transported object and limits unwanted lateral movement of the transported object.

It is a further object of the present invention to provide a device and method for the transport of lengthy objects on a pick-up truck that is small and portable.

It is yet another object of the present invention to provide a small portable device a for the transport of lengthy objects that is foldable for easy storage.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of the present invention.

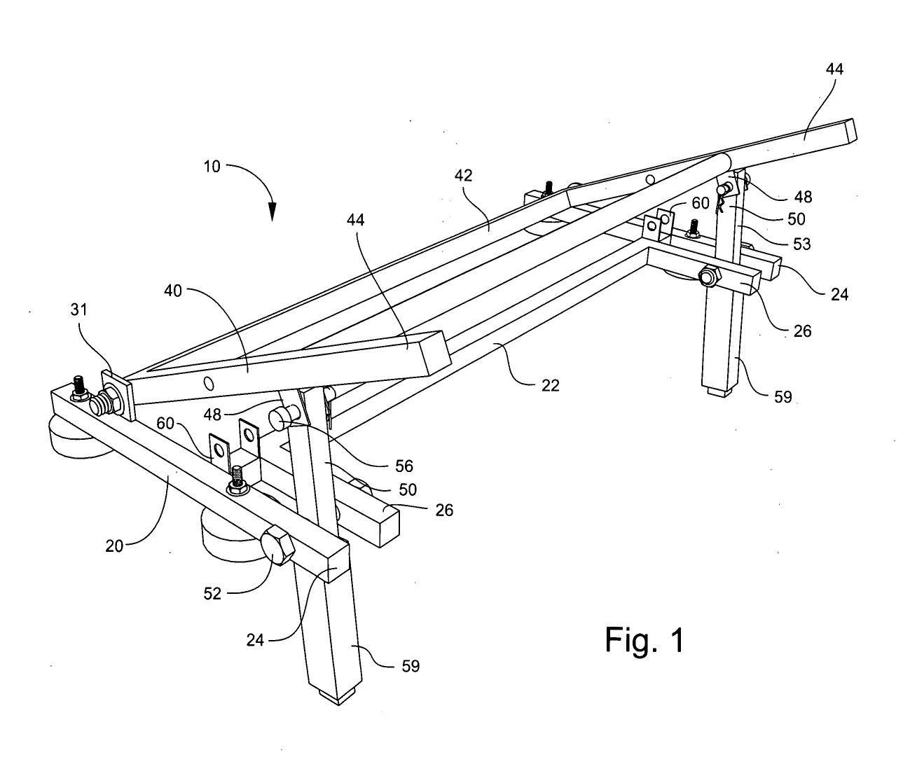

FIG. 2 is an exploded view of the perspective view FIG. 1.

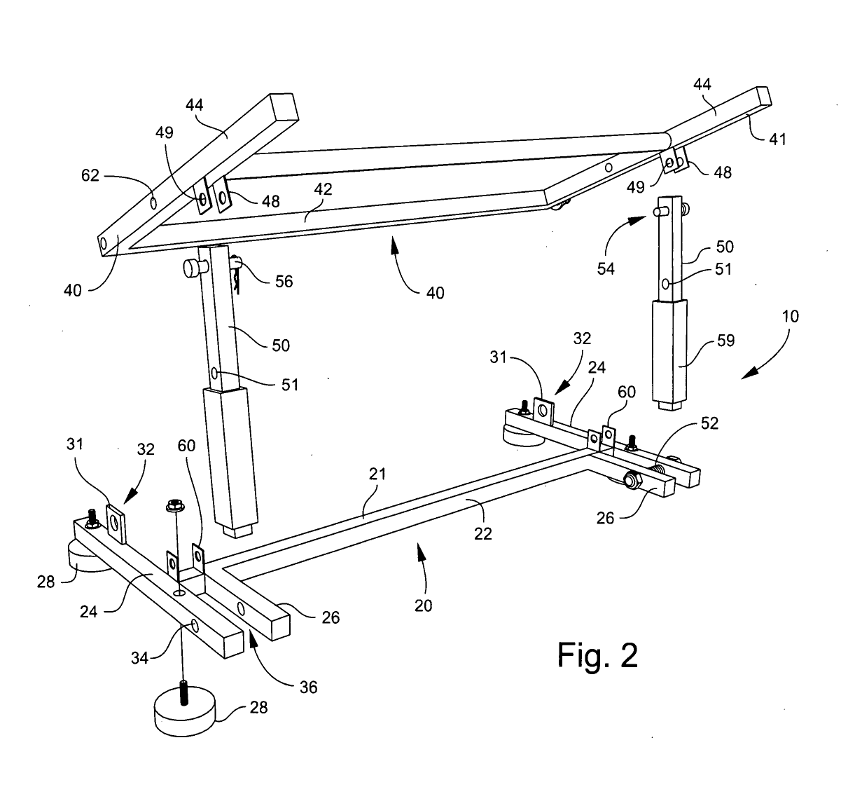

FIG. 3 is an alternate perspective view of the present invention.

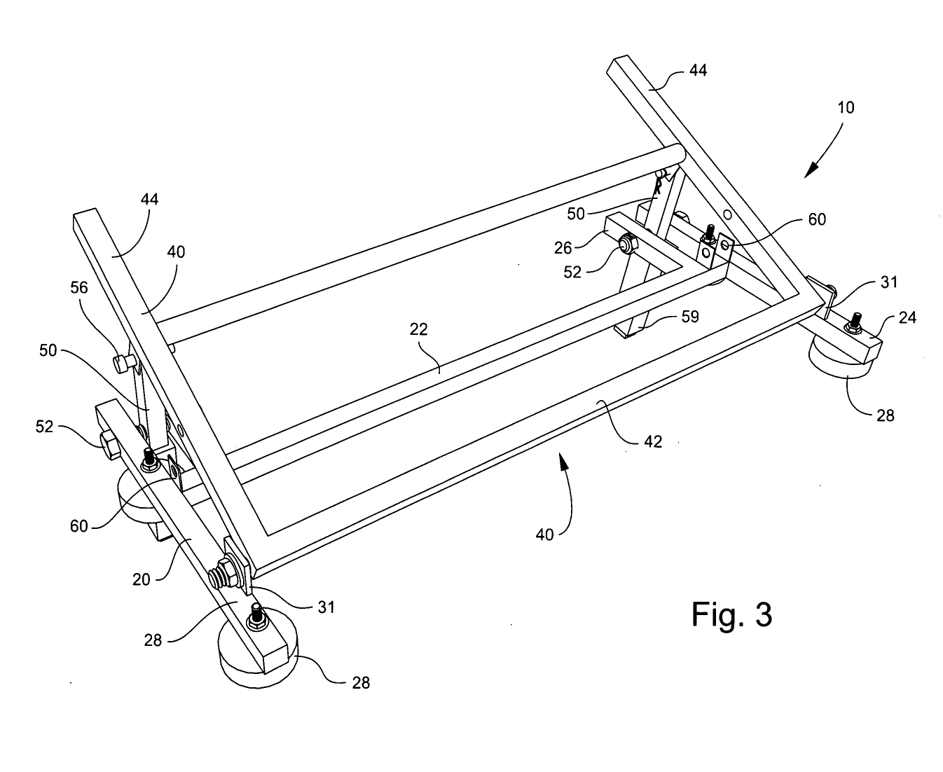

FIG. 4 is yet another alternate perspective view of the present invention.

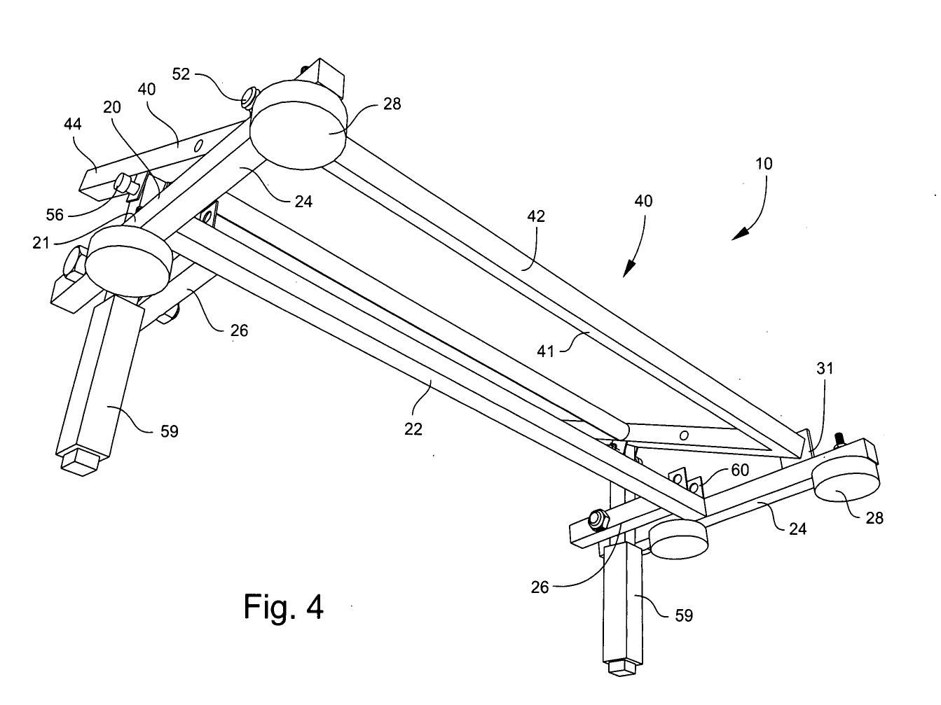

FIG. 5 is an illustration of the present invention is a closed configuration.

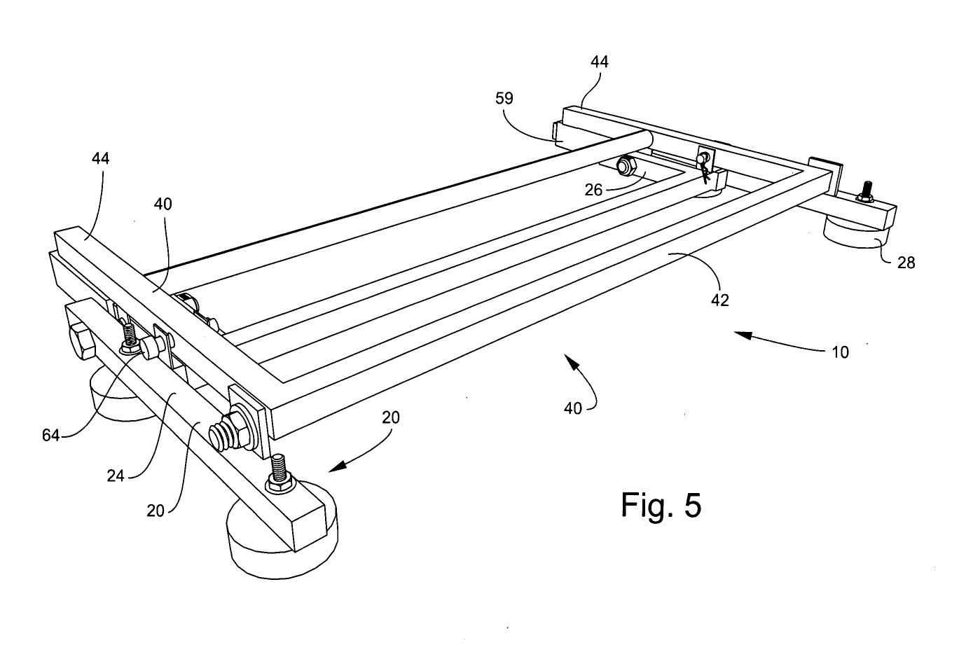

FIG. 6 is a side view of the present invention.

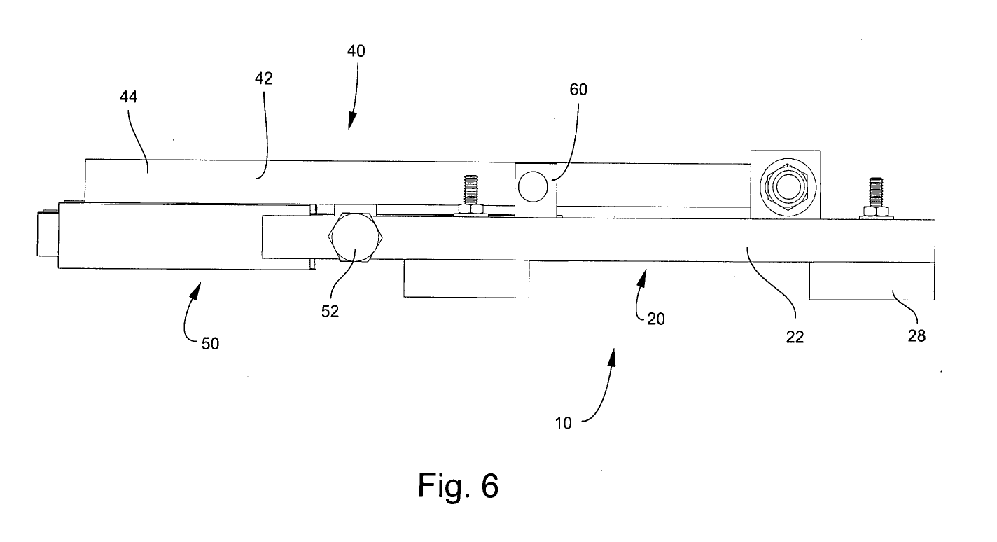

FIG. 7 illustrates the present invention deployed on the cab of a truck.

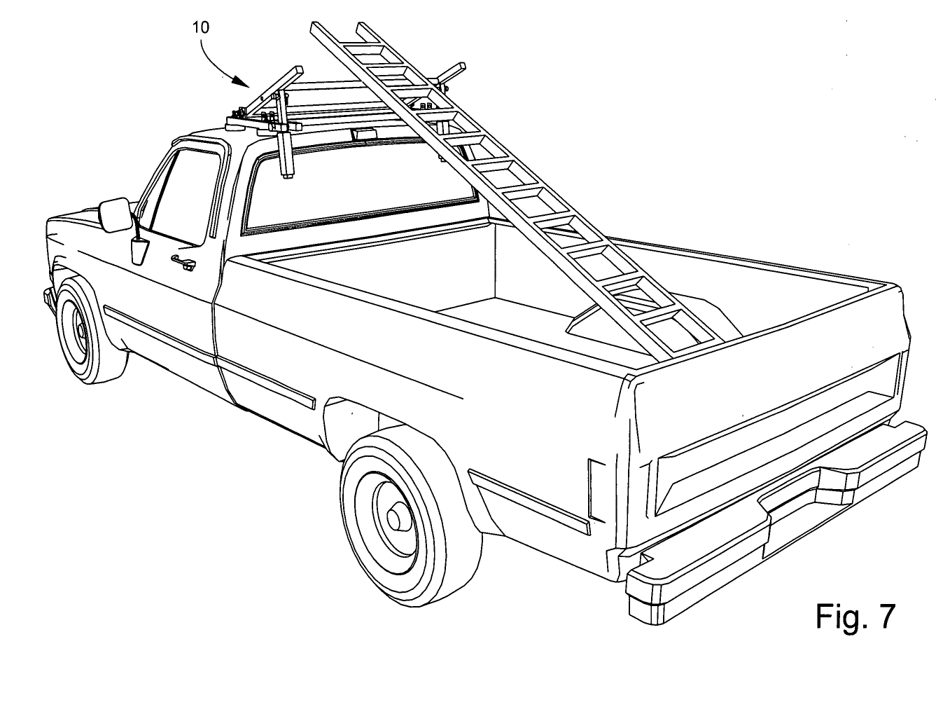

FIG. 8 illustrates the present invention deployed in an open position and also, in dashed lines, in a closed and stored position.

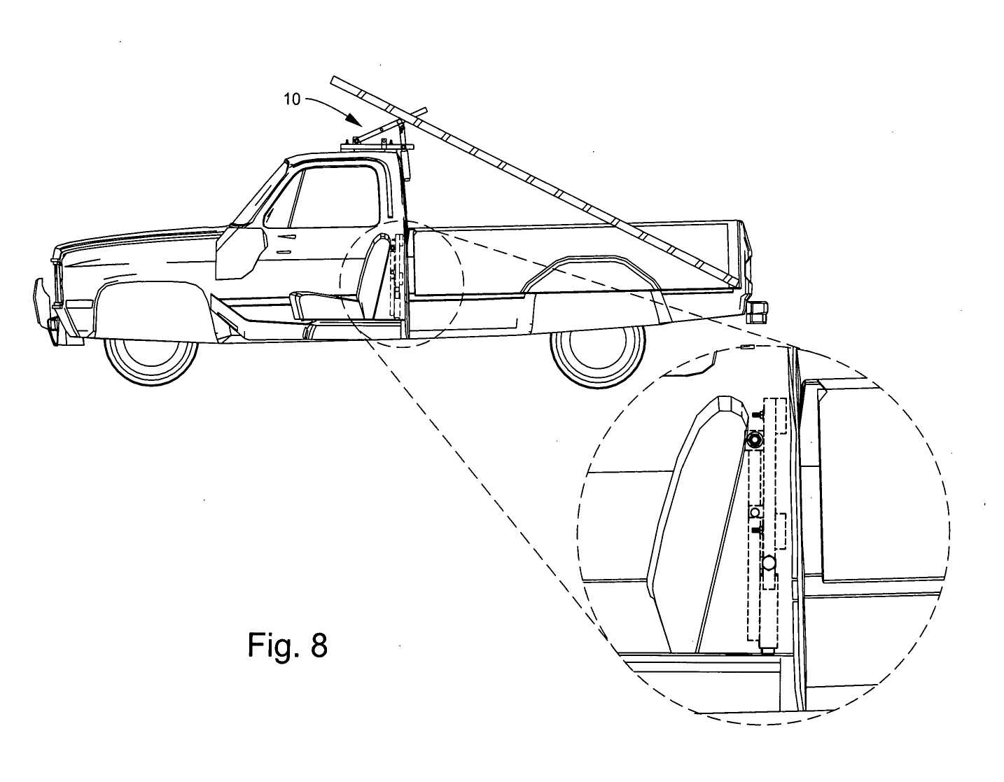

### DESCRIPTION OF PREFERRED EMBODIMENTS

The device and method according to the present invention are useful for limiting unwanted movement of lengthy objects being transported by a pick-up truck. More specifically, helps prevent the loss of these lengthy objects during transport.

With reference to the figures, the kit according to the present invention is comprised of two separate units that are used with each other. There is a first unit that is a cab protection unit 10. The cab protection unit 10 is removably mountable on a top surface of the cab of the pick-up. There is a second unit, a strap unit. The strap unit is secured at one end to the bed of the truck.

The cab protection unit 10 comprises a main frame 20 pivotally attached to a load bearing frame 40.

The main frame 20 is comprised of a cross bar 22. At each end of the cross bar 22 are two arms 24 attached to generally mid-point locations of the arms 24, thereby forming a generally H-shape.

In a preferred embodiment, the main frame 20 further comprises at least one, preferably two adjacent pivot support arms 26, each attached to the cross bar 22 and located on the same side of the cross bar 22. Further, preferably, the two adjacent pivot support arms 26 are each located adjacent to an arm 24 respectively.

The main frame 20 further comprises a yieldable structure 28 attached to a bottom side 21 of the main frame 20. Preferably, the yieldable structure, 28 is at least two, more preferably four, rubberized feet, at least one attached to each of the arms 24 respectively. Preferably, the rubberized feet are attached to the main frame 20 by embedding a bolt into each of the rubberized feet and inserting the threaded portion of the bolt through feet apertures located in each of the arms 24 and securing the rubberized feet with nuts and preferably washers.

In another embodiment, the yieldable structure 28 is a yieldable sheet, such as a rubberized or plastic film, that is attached to the bottom side 21 of the frame 20. In this embodiment, the yieldable sheet may partially cover the bottom side 21 of the frame 20 or entirely cover the bottom side 21 of the frame 20.

The main frame 20 further comprises two first pivot apertures 32, one located at distal end of each of the arms 24. In one embodiment, not shown, the first pivot apertures 32, are located directly in each of the arms 24 near the distal end of the arms 24. In a second embodiment, there are at least two first pivot tabs 31, one on each of the arms 24 and located near the distal end of the arms 24. Preferably the at least two first pivot tabs 31 are attached to a top surface 21′ of the main frame 20 and the two first pivot apertures 32 are located, one each, in the center of the first pivot tabs 31. In a third embodiment the at least two first pivot tabs 31 are located on the load bearing frame 40 and are attached to a bottom surface 41 of the load bearing frame 40, with the first pivot apertures 32 located, one each, in the center of the first pivot tabs 31.

The main frame 20 further comprises two second pivot apertures 34, one located at a proximal end of each of the arms 24. In one embodiment, the second pivot apertures 34, are located directly in each of the arms 24 near the proximal end of the arms 24. In a second embodiment, there are two third pivot apertures 36, one located at a proximal end of each of the two adjacent pivot support arms 26. In a third embodiment, not shown, there are at least two second pivot tabs, one on each of the arms 24 and located near the proximal end of the arms 24. Preferably the at least two second pivot tabs are attached to a top surface 21′ of the main frame 20 and the two second pivot apertures 34 are located, one each, in the center of the second pivot tabs 31. In a fourth embodiment, not shown, the at least two second pivot tabs are located on the distal end of the bottom surface of the load bearing frame 40 and the two second pivot apertures 34 are located, one each, in the center of the second pivot tabs 31

The cab protection unit 10 further comprises the load bearing frame 40. The load bearing frame 40 preferably comprises a generally rectangular body 42 with at least two load retention arms 44 attached to a proximal side of the generally rectangular body 42. Preferably, there are two load retention arms 44, one for each side the load bearing frame 40, but additional load retention arms may be attached and still fall within the scope of the present invention. Preferably, the load retention arms 44 are linear in shape, but other shapes, such as arcuate, may be used and still fall within the scope of the present invention. Preferably, the load retention arms 44 are fixedly attached to the load bearing frame, but may be removably attached and still fall within the scope of the present invention.

Located at, or near a distal end of the load bearing frame 40 are at least two fourth pivot apertures 46, one located at each side of the distal end of the load bearing frame 40. In one embodiment, the fourth pivot apertures 46, are located directly in the load bearing frame 40 near the distal end of the load bearing frame 40.

The load bearing frame 40 preferably also comprises at least one preferably two, more preferably four, locking tabs 48 attached to the bottom surface of the load bearing frame. Located in the middle of each locking tab 48 is a locking tab aperture 49.

Pivotally attached near the proximal end of the load bearing frame 40 are at least one, preferably two, support arms 50. Each support arm 50 is pivotally attached through a support arm pivot aperture 51, with a pivot pin 52 running through one of the second pivot apertures 34 of the main frame 20. Preferably, the length of each of the support arms 50 is such that the support arm 50 may be rotated into the plane of the main frame 20 with a top end 53 of the support arm 50 near or adjacent to the cross bar 22. Located near the top end 53 of at least one of the support arms 50 is an open position locking structure that includes a locking aperture 54 that lines up with at least one of the locking tab apertures 49 such that a lock pin 56 may be inserted through the locking apertures 54 and locking tab apertures 49, thereby securing the support arms 50, the main frame 20 and load bearing frame 40 into position relative to each other.

In a preferred embodiment the bottom end of the support arms 50 are covered with a resilient covering 59 thereby protecting the cab of a truck from being marred by the bottom end of the support arms 50.

In a preferred embodiment the main frame 20 also a closed position locking structure that includes at least one, preferably two, more preferably four, closed position locking tabs 60 attached to the top surface 21 of the main frame 20. Also, in this embodiment, there will be at least one, preferably two, closed position locking aperture 62 located on the load bearing frame 40 and positioned such that when the cab protection unit 10 is in a closed position the closed position locking tabs 60 match up with the closed position locking apertures 62 thereby allowing a closed position locking pin 64 to be inserted through the closed position locking tabs 60 and through the closed position locking aperture 62. In another embodiment, the closed position locking tabs 60 are located on the load bearing frame 40 and the closed position locking apertures are located on the main frame 20. In still yet another embodiment, the closed position locking apertures are located in second closed position locking tabs (not shown) attached to either the load bearing frame 40 or the main frame 20, respectively as required.

In use, the cab protection unit 10 is taken from a folded position, the load bearing frame 40 is pivotally opened relative to the main frame 20 into an open position. The at least one support arms 50 are locked into place, thereby preventing unwanted collapse of the cab protection unit 10. The cab protection unit 10 is then place upon the top of the cab of a truck or other vehicle, with the yieldable structure 20 and resilient covering 59 in contact with the cab of the truck. A ladder, or other elongated object, is placed in the bed of the truck, with a portion resting upon the generally rectangular body 42, between the at least two retention arms 44. The load, and cab protection unit 10 are then secured into place with the strap unit, thereby preventing unwanted movement, such as loss, of the elongated object.

In order to store the cab protection unit 10, the cab protection unit 10 in moved into a closed position by reversing the opening steps described above. The load bearing frame 40 may then be locked into place relative to the main frame 20 by inserting the closed position locking pin 64 through the closed position locking tabs 60 and through the closed position locking aperture 62

In an alternate embodiment, the at least one support arms 50 are attached to the load bearing frame 40 with a slide structure that automatically deploys and positions the support arms 50 into the proper position when opening or closing the cab protection unit 10. this slide structure may also include a locking mechanism that automatically locks or unlocks the support arms 50 when opening or closing the cab protection unit 10, respectively.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A cab protection unit comprising a main frame pivotally attached to a load bearing frame;
a) the main frame comprising
i. a cross bar with to arms attached at each end of the cross bar;
ii. a yieldable structure attached to a bottom side of the main frame; and
iii. at least one support arm pivotally attached to at least one of the arms and configured to secure the load bearing frame into an open position; and
b) the load bearing frame comprising
i. a body having at least two load retention arms attached to one side of the body.

2. The cab protection unit according to claim 1 wherein the at least one support arm is pivotally attached to the arms in a position such that the at least one support arm may be rotated into a closed position adjacent to the arm of the main frame and in the plane of the main frame.

3. The cab protection unit according to claim 1 wherein the main frame further comprises at least one pivot support arms attached to the main frame adjacent to the arms.

4. The cab protection unit according to claim 3 wherein the at least one support arm is pivotally attached to the arms in a position such that the at least one support arm may be rotated into a closed position between the at least one pivot support arm and the arm of the main frame and in the plane of the main frame.

5. The cap protection unit according to claim 1 further comprising an open position locking structure that is adapted to lock the cab protection unit into an open position.

6. The cab protection unit according to claim 1 further comprising a closed position locking structure that is adapted to lock the cab protection unit into a closed position.

7. The cab protection unit according to claim 5 further comprising a closed position locking structure that is adapted to lock the cab protection unit into a closed position.
